(19) United States
(12) Patent Application Publication
(10) Pub. No.: US 2015/0232044 A1
(43) Pub. Date: Aug. 20, 2015

(54) LATEX IMPREGNATED FIBROUS ACOUSTIC INSULATOR

(71) Applicant: Cadillac Products Automotive Company, Troy, MI (US)

(72) Inventors: Michael P. Demo, Macomb Township, MI (US); Kenneth Ritzema, Clarkston, MI (US)

(21) Appl. No.: 14/623,211

(22) Filed: Feb. 16, 2015

Related U.S. Application Data
(60) Provisional application No. 61/939,839, filed on Feb. 14, 2014.

(51) Int. Cl. B60R 13/08; B32B 37/14; B32B 15/14

(52) U.S. Cl. CPC B60R 13/08; B32B 15/14; B32B 37/144; B32B 2255/02; B32B 2319/00

(57) ABSTRACT

A fibrous acoustic insulator includes a nonwoven mat having at least a first layer impregnated with a thermoset polymeric material that is liquid-based. A second layer oppositely facing with respect to the first layer is also impregnated with the thermoset polymeric material. An un-impregnated nonwoven material layer defining an inner layer is positioned between the first and second layers. The un-impregnated nonwoven material layer may be shoddy and does not include the thermoset polymeric material, thereby defining an untreated nonwoven material layer.

### CROSS-REFERENCE TO RELATED APPLICATIONS

The present application claims the benefit of U.S. Provisional Application No. 61/939,839, filed on Feb. 14, 2014. The entire disclosure of the above application is incorporated herein by reference.

### FIELD

The present disclosure relates to acoustic insulator materials and products used particularly in automobile vehicle applications.

### BACKGROUND

This section provides background information related to the present disclosure which is not necessarily prior art.

Automobile vehicles include acoustic insulation in multiple locations inside and outside a vehicle passenger compartment to reduce vehicle and road noise during operation. Three major methods of noise control are used in vehicles: (1) reducing noise and vibration sources; (2) applying barriers and other treatments to block sound from entering the passenger compartment; and (3) applying sound absorbers in both the exterior and the interior of the vehicle to dissipate sound and thereby reduce overall sound level.

Acoustic insulation made of cotton “shoddy” or fibrous woven or mat material can conform to substantially any vehicle component shape, and may contain thermoplastic fibers or a thermoset resin powder to group the cotton fibers and maintain a mat thickness. The thermoplastic fibers or thermoset resin powder in the acoustic insulation thus act as binders within the mat material and are solid-based (not liquid-based). Known shoddy mat however, has low thermal operating temperature limits (approximately 240 to 250 degrees Fahrenheit maximum) above which the mat droops or loses its shape, and is therefore not used in high temperature locations, or unsupported locations requiring retention of a preformed shape. Known shoddy is therefore commonly used in locations where the shoddy mats are mechanically retained or held in position by other components such as trim or dashboard members. Typically, molded shoddy mat is therefore not currently used in locations where the shoddy is exposed to temperatures above approximately 250 degrees Fahrenheit, such as in engine compartments, locations where the material is positioned horizontally and cannot be supported throughout, or where the material is subject to wind or weather. Known molded shoddy mat also does not meet the Underwriters Laboratory (UL) 94 V-0 automotive standard for burn resistance for high temperature locations (temperatures exceeding approximately 250 to 400 degrees Fahrenheit).

For applications that require rigidity and that must meet the Underwriters Laboratory (UL) 94 V-0 automotive standard, vehicles commonly use fiberglass acoustic insulation in panel form that is molded to a predetermined geometry. Vehicle applications using either the thermoplastic embedded shoddy material insulation panels or fiberglass panels include, but are not limited to applications such as underbody aero shields, dash mats, wheel wells, hoods, cowls, interior tunnels, exterior tunnels, back panel insulators, head liners, interior dash panels and package shelves.

While conventional fiberglass acoustic insulation panels meet the Underwriters Laboratory (UL) 94 V-0 automotive standard for burn resistance, conventional fiberglass acoustic insulation panels create material handling problems. Conventional fiberglass acoustic insulation panels are made up of very small glass fibers. When handled by workers during the manufacturing of the insulation panels, assembly of the vehicle, and/or disassembly of the vehicle for repair or scrapping, these glass fibers cause irritation when they come in contact with exposed skin and can also cause respiratory problems if they become airborne. Accordingly, such workers are often required to wear protective clothing, gloves, and/or respirators. Due to these known material handling problems, fiberglass acoustic panels may be provided with protective cloth scrims on both sides of the fiberglass such that the glass fibers are not exposed. However, such scrims typically do not meet the Underwriters Laboratory (UL) 94 V-0 automotive standards for burn resistance, making their use in high temperature locations less desirable. What is needed is an alternative to conventional fiberglass acoustic insulation panels that meets the Underwriters Laboratory (UL) 94 V-0 automotive standard for burn resistance and does not have the material handling drawbacks of conventional fiberglass acoustic insulation panels.

### SUMMARY

This section provides a general summary of the disclosure, and is not a comprehensive disclosure of its full scope or all of its features.

According to several aspects, a fibrous acoustic insulator includes a nonwoven mat having at least a first layer of nonwoven material impregnated with a thermoset polymeric material that is liquid-based.

According to other aspects, a fibrous acoustic insulator includes a nonwoven mat having a first layer impregnated with a thermoset polymeric material that is water-based latex. A second layer oppositely facing with respect to first layer is also impregnated with the thermoset polymeric material. An inner layer between the first and second layers is not impregnated with the thermoset polymeric material, therefore defining an untreated, un-impregnated nonwoven material layer, which may be made of shoddy.

According to other aspects, a method for forming a fibrous acoustic insulator includes the steps of: supporting a nonwoven mat using multiple rollers of a rolling machine; guiding the nonwoven mat onto a drum roller of the rolling machine; spraying a thermoset polymeric material onto a first surface of the nonwoven mat; passing the nonwoven mat between the drum roller and a sizing roller such that the thermoset polymeric material penetrates the first surface to less than or equal to about 30% of a thickness of the nonwoven mat; and heating the nonwoven mat to cure the thermoset polymeric material.

Advantageously, the fibrous acoustic insulator disclosed meets the rigidity and flammability requirements for use in high temperature locations of a vehicle (where temperatures exceed approximately 250 to 400 degrees Fahrenheit). Unlike conventional shoddy mats that are prone to droop and lose their shape at high temperatures, the disclosed fibrous acoustic insulator has superior rigidity and retains its shape at high temperatures due to the presence of the thermoset polymeric material in the first layer of the nonwoven mat. The disclosed fibrous acoustic insulator is well suited for high temperature locations and requires less support (fewer retention locations) because it holds its shape. Unlike conventional shoddy mats, the fibrous acoustic insulator disclosed meets Underwriters Laboratory (UL) 94 V-0 automotive standards for burn resistance and other less stringent flammability requirements. At the same time, the disclosed fibrous acoustic insulator provides superior acoustic attenuation and does not have the same material handling drawbacks as conventional fiberglass acoustic insulation panels. As a result, the disclosed fibrous acoustic insulator does not require special handing precautions or scrims.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an end elevational view of an un-impregnated shoddy fiber mat;

FIG. 2 is an end elevational view of an impregnated fibrous acoustic insulator mat of the present disclosure having a single impregnated layer;

FIG. 3 is an end elevational view of an impregnated fibrous acoustic insulator mat having a continuous impregnated layer of liquid-based thermoset polymeric material;

FIG. 4 is an end elevational perspective view of an impregnated fibrous acoustic insulator mat of the present disclosure having first and second outside impregnated layers and an inner un-impregnated layer;

FIG. 5 is a top perspective view of an impregnated fibrous acoustic insulator mat of the present disclosure formed to a finished geometry;

FIG. 6 is a diagram of a process and applicator for manufacturing impregnated fibrous acoustic insulator mats of the present disclosure;

FIG. 7 is a front left perspective view of a machine for spray coating fibrous acoustic insulator mats of the present disclosure with a liquid-based thermoset polymeric material;

FIG. 8 is a cross sectional front elevational view of the finished impregnated fibrous acoustic insulator mat of the present disclosure taken along section line 8-8 in FIG. 5;

FIG. 9 is a graph of sound absorption coefficient performance comparing impregnated fibrous acoustic insulator mats of various thicknesses to known fiberglass material mats over a frequency range of approximately 1000 Hz to 6300 Hz; and

FIG. 10 is a graph of sound absorption coefficient performance comparing impregnated fibrous acoustic insulator mats of various thicknesses to known fiberglass material mats over a frequency range of approximately 100 Hz to 6300 Hz.

Corresponding reference numerals indicate corresponding parts throughout the several views of the drawings.

### DETAILED DESCRIPTION

Example embodiments will now be described more fully with reference to the accompanying drawings.

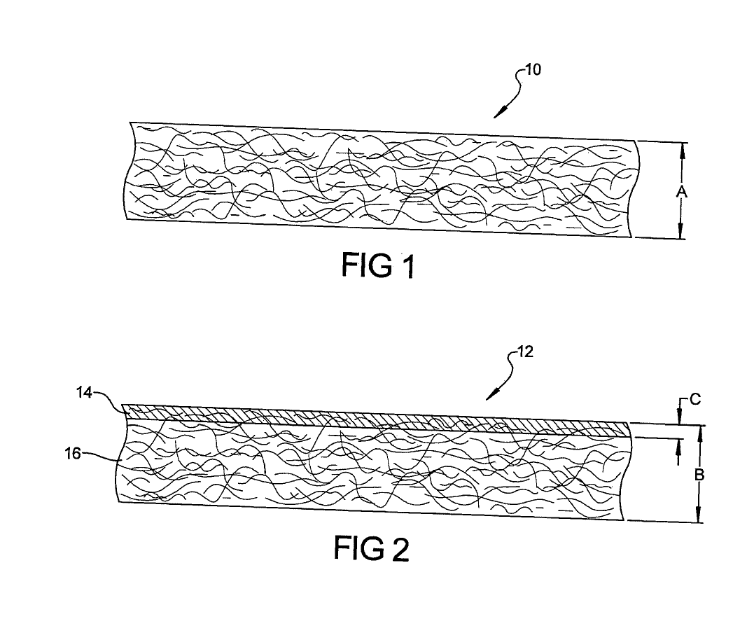

Referring to FIG. 1, a nonwoven mat 10 is made from a layer of fibers pressed together to a base thickness “A”. The nonwoven mat 10 may be made of a variety of different materials, including without limitation shoddy, polyester, or fiberglass. Shoddy typically includes a synthetic material, a natural material, a combination of synthetic and natural material, virgin or recycled material, or post industrial material consumer material. Such natural materials may include, without limitation, cotton. In the example illustrated in FIG. 1, the nonwoven mat 10 is a shoddy mat 10. Shoddy mat 10 may contain a percentage of a thermoplastic material used to bind the fibers together such that the base thickness “A” can be retained. This thermoplastic material is typically thermoplastic fibers or a thermoset resin powder. These materials are applied in a solid state during production of the shoddy mat 10 and are thus solid-based. The base thickness “A” of shoddy mat 10 can be varied. As the thickness “A” of the shoddy mat 10 increases, acoustic attenuation increases. However, increasing the base thickness “A” also increases a weight and cost of the shoddy mat 10, as well as limiting the locations where the shoddy mat 10 can be used due to size constraints.

Referring to FIG. 2 and again to FIG. 1, shoddy mat 10 has been modified to create a latex impregnated fibrous acoustic insulation mat 12 in accordance with the present disclosure. Latex impregnated fibrous acoustic insulation mat 12 has a nominal body thickness “B” which is equal to or less than base thickness “A” of shoddy mat 10. Latex impregnated fibrous acoustic insulation mat 12 includes at least a first layer 14 impregnated with a thermoset polymeric material that is liquid-based. The term “liquid-based” as used herein means that the thermoset polymeric material is in a liquid state when it is applied to the nonwoven/shoddy mat 10. As will be explained in greater detail below, the thermoset polymeric material in the first layer 14 cures (solidifies) after it is applied by subjecting the latex impregnated fibrous acoustic insulation mat 12 to heat. This stands in contrast to the solid-based thermoplastic fibers or thermoset resin powder that act as a binder in the shoddy mat 10. By way of example and without limitation, the liquid-based thermoset polymeric material that is impregnated in the first layer 14 may be a water-based acrylic latex or a water-based acrylic latex foam. One exemplary water-based acrylic latex is Acrodur®, an acrylic copolymer manufactured by the BASF Corporation. In some embodiments, the dry weight of the thermoset polymeric material may be 10% to 60% of the dry weight of the latex impregnated fibrous acoustic insulation mat 12. In other words, 10% to 60% of the dry weight of the latex impregnated fibrous acoustic insulation mat 12 may be attributed to the weight of the thermoset polymeric material.

An un-impregnated layer 16 is also provided which is not impregnated by the thermoset plastic acrylic latex material, and is therefore untreated, un-impregnated shoddy material. According to several aspects, the first layer 14 can have a thickness “C” which represents penetration of the thermoset plastic acrylic latex to approximately 5 to 30% of the body thickness “B”. Latex impregnated fibrous acoustic insulation mats of the present disclosure with penetration of the thermoset plastic acrylic latex to approximately 5 to 30% of the body thickness “B” and having a final loft or thickness of at least 3 mm will provide sound absorption capability.

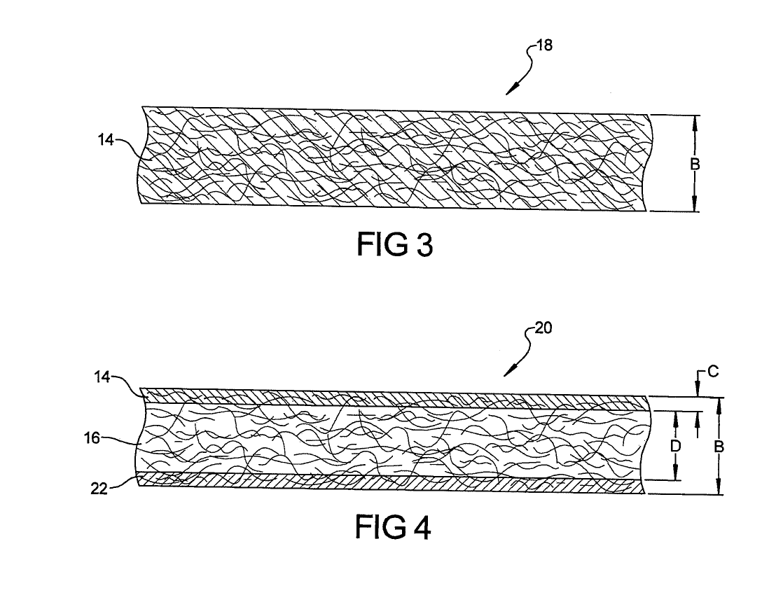

Referring to FIG. 3 and again to FIG. 2, a latex impregnated fibrous acoustic insulation mat 18 is modified from latex impregnated fibrous acoustic insulation mat 12 to provide full penetration of the thermoset plastic acrylic latex into the shoddy material. The first layer 14 in this aspect has a thickness “B” which represents penetration of the thermoset plastic acrylic latex to substantially 100% of the body thickness “B”.

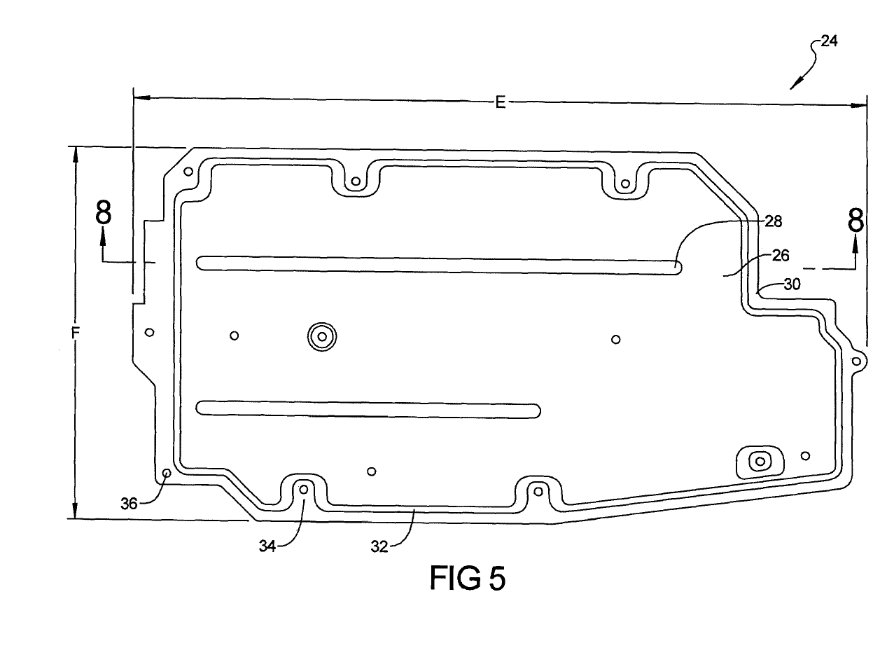

Referring to FIG. 4 and again to FIGS. 2-3, according to other aspects, a latex impregnated fibrous acoustic insulation mat 20 is modified from latex impregnated fibrous acoustic insulation mat 12 to further include a second layer 22 oppositely facing with respect to first layer 14, which is also impregnated with the thermoset plastic acrylic latex material. Latex impregnated fibrous acoustic insulation mat 20 includes first layer 14 and second layer 22 both impregnated with the thermoset plastic acrylic latex material, and the un-impregnated layer 16 such that un-impregnated layer 16 is positioned between first and second layers 14, 22.

According to several aspects, each of the first and second layers 14, 22 can have the common thickness “C” which represents penetration of the thermoset plastic acrylic latex to approximately 5 to 30% of the body thickness “B”. According to other aspects, each of the first and second layers 14, 22 can have a different thickness after impregnation by the thermoset plastic acrylic latex. A thickness “D” of inner layer 16 can therefore vary between approximately 40% up to approximately 90% of the total body thickness “B”. By stiffening the outer portions of the insulation mat 12 using the thermoset plastic acrylic latex, the first and second layers 14, 22 of latex impregnated fibrous acoustic insulation mat 20 create an I-beam rigidity, resisting lateral and torsional bending and acting to retain the mat geometry.

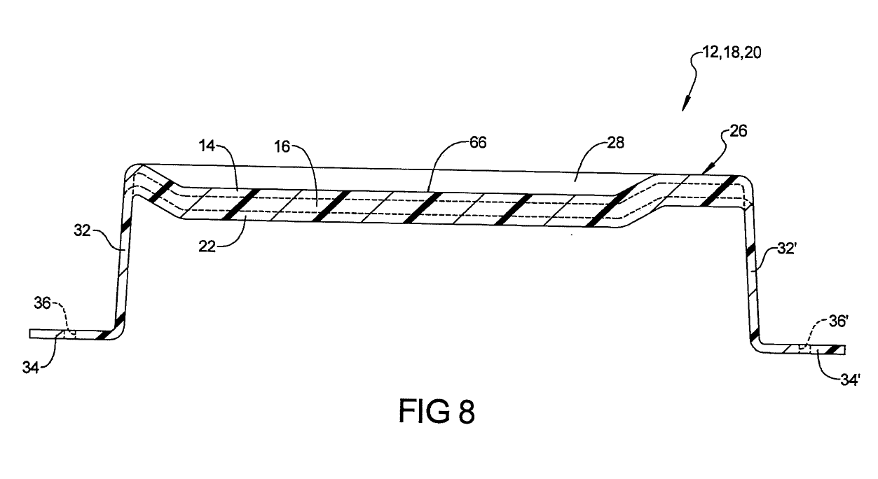

Referring to FIG. 5 and again to FIGS. 1-4, latex impregnated fibrous acoustic insulation mat 20 has been further modified to create a vehicle underbody acoustic shield 24. Acoustic shield 24 has a substantially flat body face 26 which can include one or more raised or indented ribs 28 (ribs indented with respect to body face 26 are shown in this example) that increase a bending resistance of acoustic shield 24. An outer perimeter 30 can have any desired shape or geometry, and can include outer walls 32 which are normal to or angularly oriented with respect to body face 26. One or more flanges 34 can also be provided at one or more locations about the outer perimeter 30, which are used as an attachment or mounting surface for acoustic shield 24. Flanges 34 will be better described in reference to FIG. 8. One or more apertures 36 can be provided in either flange 34 or in body face 26 to provide mounting locations for fasteners (not shown) used to fix the acoustic shield 24 to an automobile vehicle.

A size of acoustic shield 24 is limited only by the available die and molding machine sizes used to create acoustic shield 24 and/or a surface area of the base shoddy mat material available. A length “E” and a width “F” of acoustic shield 24 in one exemplary embodiment are 57 in (144.8 cm) and 24 in (60.9 cm), however these dimensions are provided as examples only. Latex impregnated insulation mats 12, 18 and/or 20 can therefore be modified to create substantially any geometry now provided by similar fiberglass or shoddy components known in the automotive industry.

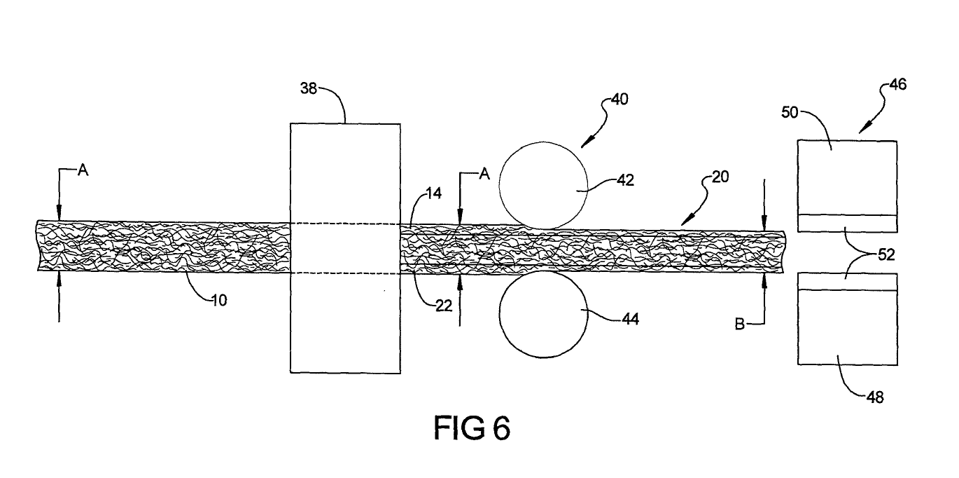

Referring to FIG. 6 and again to FIGS. 1-5, an exemplary process for preparing latex impregnated insulation mats 12, 18 and 20 of the present disclosure includes a first step of feeding the shoddy mat 10 into an application device 38. Application device 38 can be any type of applicator for applying the one or more coatings of the thermoset plastic acrylic latex and can include sprayers including spray nozzles, dip tanks, roll coaters, brushes, and the like. After the one or more layers of thermoset plastic acrylic latex material are created, the treated shoddy mat 10 may be wet or damp due to the water-based latex material. The treated shoddy mat 10 still having base thickness “A” is then moved in a second step into a sizing device 40. Sizing device 40 can include one or more rollers such as opposed first and second rollers 42, 44, one or more pressure knives or plates, or similar devices which apply an external pressure to the impregnated, treated shoddy mat 10. The pressure applied during the second step of operation provided by sizing device 40 forces the thermoset plastic acrylic latex into the shoddy material and further creates the body thickness “B”.

Following the sizing or second step, the latex impregnated fibrous acoustic insulation mat 12, 18, or 20 can be moved to a die/press 46 which in a third step both heats the latex impregnated insulation mat to a temperature of approximately 400 degrees Fahrenheit to cure the thermoset acrylic latex material and can further create the finished shape such as the acoustic shield 24 described in reference to FIG. 4. By heating the latex impregnated fibrous acoustic insulation mat 12, 18, or 20 during this step, the liquid (e.g. water) in the liquid-based thermoset polymeric material cooks off (evaporates) such that the thermoset polymeric material cures and thus makes the latex impregnated fibrous acoustic insulation mat 12, 18, or 20 more rigid. Die/press 46 can include a fixed portion 48 and a moving portion 50. Either or both of the fixed portion 48 and/or the moving portion 50 can be provided with a heat source 52 to generate the curing temperature. It should also be appreciated that one or more scrims may optionally be applied to the latex impregnated fibrous acoustic insulation mat 12, 18, or 20 after the thermoset polymeric material is applied to the latex impregnated fibrous acoustic insulation mat 12, 18, or 20, but before the thermoset polymeric material cures. Because the thermoset polymeric material is liquid-based, the scrim soaks up some of the thermoset polymeric material. Advantageously, the thermoset polymeric material improves the burn resistance of the scrim such that the latex impregnated fibrous acoustic insulation mat 12, 18, or 20 and the associated scrim can meet the Underwriters Laboratory (UL) 94 V-0 automotive standards for burn resistance.

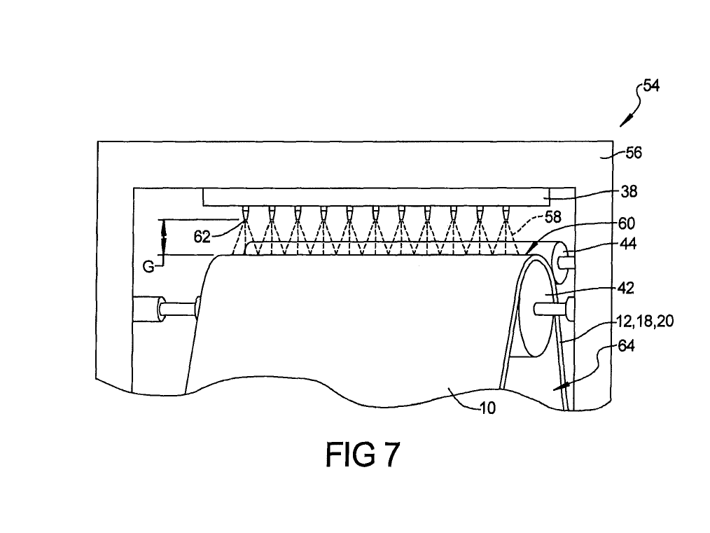

Referring to FIG. 7 and again to FIGS. 1-6, manufacture of latex impregnated fibrous acoustic insulation mats 12, 18, or 20 can be accomplished using the following exemplary spraying process. An application machine 54 provides a frame 56 from which pressure application members such as first and second rollers 42, 44 are supported. As shoddy mat 10 reaches an upper portion of the first roller 42, a water-based latex thermoset polymeric material 58 is applied such as by spraying onto a first outer surface 60 of shoddy mat 10. According to some aspects, the thermoset polymeric material 58 is provided in a solution including water and defines a solids content of the solution ranging between approximately 10% to approximately 75% of a volume of the solution. The solids content, a flow or application rate, a pressure applied, a temperature of the solution containing latex thermoset polymeric material 58, and a rotational speed of first roller 42 are variables used to control penetration of latex thermoset polymeric material 58 into the exposed first outer surface 60. The latex thermoset polymeric material 58 is injected through multiple spray nozzles 62, fed by the application device 38, which receive a pressurized flow of latex thermoset polymeric material 58 from a material source (not shown). The spray nozzles 62 are aligned to provide a common, predetermined clearance “G” between the spray nozzles 62 and the first outer surface 60. Once the first outer surface 60 has been treated with latex thermoset polymeric material 58, the treated insulation mat 12, 18, or 20 is nip rolled and then can be passed between first roller 42 and second roller 44, which together act to increase penetration of the latex thermoset polymeric material 58 into the first outer surface 60. It should be appreciated that the term “nip rolled” as used herein means that the thickness “B” of the treated insulation mat 12, 18, or 20 is reduced at a nip point adjacent a nip roller and is then allowed to rebound back after the nip point to at least some extent. In other words, the loft of the treated insulation mat 12, 18, or 20 decreases at first and then increases again to some extent as the treated insulation mat 12, 18, or 20 is nip rolled.

After the first outer surface 60 has been treated with latex thermoset polymeric material 58 and pressed, the partially impregnated shoddy mat can be reversed and re-fed through application machine 54 such that a second outer surface 64, which is oppositely facing with respect to first outer surface 60, has latex thermoset polymeric material 58 applied thereto. The penetration of latex thermoset polymeric material 58 into second outer surface 64 can be to 30% of the body thickness similar to first outer surface 60, or can vary as noted above. According to further aspects, the amount of penetration of the latex thermoset polymeric material 58 can be varied between first and second outer surfaces 60, 64 as desired. Application machine 54 can also be set up to simultaneously spray both the first and second outer surfaces 60, 64. According to further aspects, the latex thermoset polymeric material 58 can be applied to only one of the first or second outer surfaces 60, 64 as desired. Depending on the solids percentage of the latex thermoset polymeric material 58 in the solution, the latex thermoset polymeric material 58 in solution can be applied to one or more surfaces of shoddy mat 10 and allowed to wick or penetrate into shoddy mat 10 to create the one or more layers 14, 22, without the use of applied pressure. However, according to several aspects pressure is applied to the surface having the latex thermoset polymeric material 58 to force penetration of the latex thermoset polymeric material 58 to the desired penetration. As an alternative to applying pressure to the first outer surface 60 and/or the second outer surface 64 to increase penetration of the latex thermoset polymeric material 58, the fluid pressure of the latex thermoset polymeric material 58 may be increased at the spray nozzles 62 to achieve greater penetration into the shoddy mat 10.

As previously noted, after coating with latex thermoset polymeric material 58, insulation mat 12, 18, and/or 22 requires heating to approximately 400 degrees Fahrenheit for approximately 20 seconds to cure latex thermoset polymeric material 58. As previously noted the die and/or press used to create the finished acoustic insulator geometry can provide a heating system such that uncured, latex impregnated insulation mats 12, 18, 22 can be cured at a curing temperature of approximately 400 degrees Fahrenheit by the concurrent application of heat and pressure during the press operation. Alternately, latex impregnated insulation mats 12, 18, and/or 22 can be heated in an oven or by similar heating system to complete the curing process. The impregnated and cured insulation mats 12, 18, and/or 22 can be then moved to a cutting die or other machine to create an acoustic insulator of any desired shape.

In addition to the water-based acrylic latex or water-based acrylic latex foam previously identified herein, latex thermoset polymeric material 58 can also be a urethane, an ionomer, or a co-polymer of any of the above materials, all of which can be treated to meet the Underwriter Laboratory (UL) 94 V-0, V-1, V-2 and/or FMVSS 302 automotive standards for burn resistance. Latex thermoset polymeric material 58 mixed with water to form a solution can be applied as an emulsion and also as a foam.

Referring to FIG. 8 and again to FIGS. 2-7, the completed latex impregnated insulation mats 12, 18, 20 can be cut and shaped to a finished component geometry such as a vehicle well acoustic liner, an underbody aero-shield, a hood or trunk liner, a dashboard panel, a tunnel insulator, a back-panel insulator, a cowl insulator, or any desired vehicle insulator during the same step used to heat and cure the latex thermoset polymeric material 58. Alternately, the cured and impregnated insulation mats 12, 18, 20 in mat form can be moved to a die cutting machine to provide the desire finished shape. Features such as the raised or indented ribs 28, flanges 34, 34′, outer walls 32, 32′, and apertures 36, 36′ are formed by the press operation, and the cured latex thermoset polymeric material 58 ensures the desired geometry is retained at elevated temperatures in the finished component such as acoustic shield 24.

Acoustic shield 24 according to several aspects retains the latex impregnated first layer 14, the latex impregnated second layer 22, and the un-impregnated inner layer 16 in a main body portion 66. Main body portion 66 therefore provides full acoustic attenuation properties. In each of the at least one flange 34, 34′ the inner layer 16 is fully compressed between the latex impregnated first and second layers 14, 22 and the first and second layers 14, 16 are at least partially compressed. A thickness of the flange 34, 34′ can be reduced from the approximate initial body thickness “B” of approximately 20 to 25 mm to a compressed thickness of approximately 1.5. mm. The inner layer 16 at the flanges 34, 34′ and in some aspects the inner layer 16 at the outer walls 32, 32′ is therefore substantially eliminated as an acoustic attenuation material by compression, such that the flanges 34, 34′ and/or the outer walls 32, 32′ provide no acoustic attenuation or provide substantially only the acoustic attenuation properties of the latex impregnated first and second layers 14, 22. According to other aspects, the outer walls 32, 32′ are either partially compressed or are not compressed and therefore the inner layer 16 is at least partially or fully retained in the outer walls. This provides some acoustic attenuation properties in the outer walls 32, 32′.

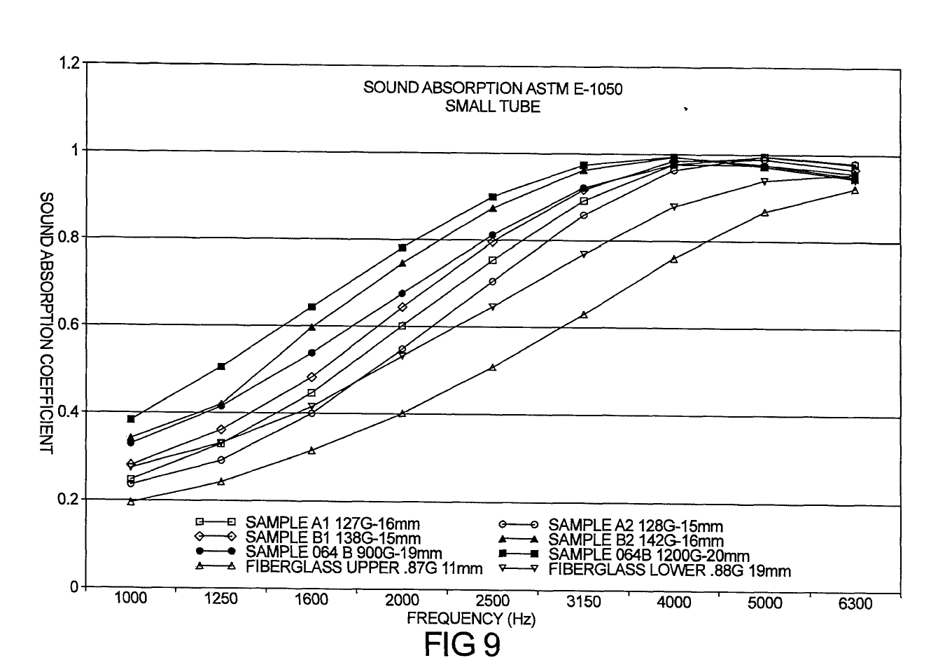

Referring to FIG. 9, small tube test data is illustrated comparing the acoustic attenuation of several samples of the latex impregnated fibrous acoustic insulation mats 12, 18 and/or 22 of the present disclosure to conventional fiberglass mats of similar surface density and to non-impregnated shoddy material of greater thickness. The small tube test data is presented in a plot with an x-axis (horizontal) and a y-axis (vertical). The y-axis in FIG. 9 corresponds to a sound absorption coefficient ranging from 0 to 1.2 and the x-axis corresponds to a sound frequency ranging from 1000 Hertz (Hz) to 6300 Hertz (Hz). The several samples of the latex impregnated fibrous acoustic insulation mats 12, 18 and/or 22 tested had various thicknesses and had the geometry presented in FIG. 4. Sample A1 is a sample of the latex impregnated fibrous acoustic insulation mats 12, 18 and/or 22 of the subject disclosure having a thickness of 16 millimeters (mm) and a material weight of 127 grams per square foot (g/ft²). Sample A2 is another sample of the latex impregnated fibrous acoustic insulation mats 12, 18 and/or 22 of the subject disclosure having a thickness of 15 millimeters (mm) and a material weight of 128 grams per square foot (g/ft²). Sample B1 is another sample of the latex impregnated fibrous acoustic insulation mats 12, 18 and/or 22 of the subject disclosure having a thickness of 15 millimeters (mm) and a material weight of 138 grams per square foot (g/ft²). Sample B2 is another sample of the latex impregnated fibrous acoustic insulation mats 12, 18 and/or 22 of the subject disclosure having a thickness of 16 millimeters (mm) and a material weight of 142 grams per square foot (g/ft²). Sample 064B 900G is a sample of non-impregnated shoddy material having a thickness of 19 millimeters (mm) and a material weight of 900 grams per square meter (g/m²). Sample 064B 1200G is another sample of non-impregnated shoddy material having a thickness of 20 millimeters (mm) and a material weight of 1200 grams per square meter (g/m²). Sample FIBERGLASS UPPER is a sample of conventional fiberglass acoustic insulation material having a thickness of 11 millimeters (mm) and a material weight of 87 grams per square foot (g/ft²). Sample FIBERGLASS LOWER is a sample of conventional fiberglass acoustic insulation material having a thickness of 19 millimeters (mm) and a material weight of 88 grams per square foot (g/ft²). The test data indicates that the latex impregnated fibrous acoustic insulation mats 12, 18 and/or 22 of the present disclosure have similar acoustic performance to the untreated shoddy, and in general are acoustically superior in sound absorption to conventional fiberglass mats (having an 11 mm thickness) at all frequencies, and are acoustically superior to conventional fiberglass mats (having a 19 mm thickness) at substantially all frequencies tested.

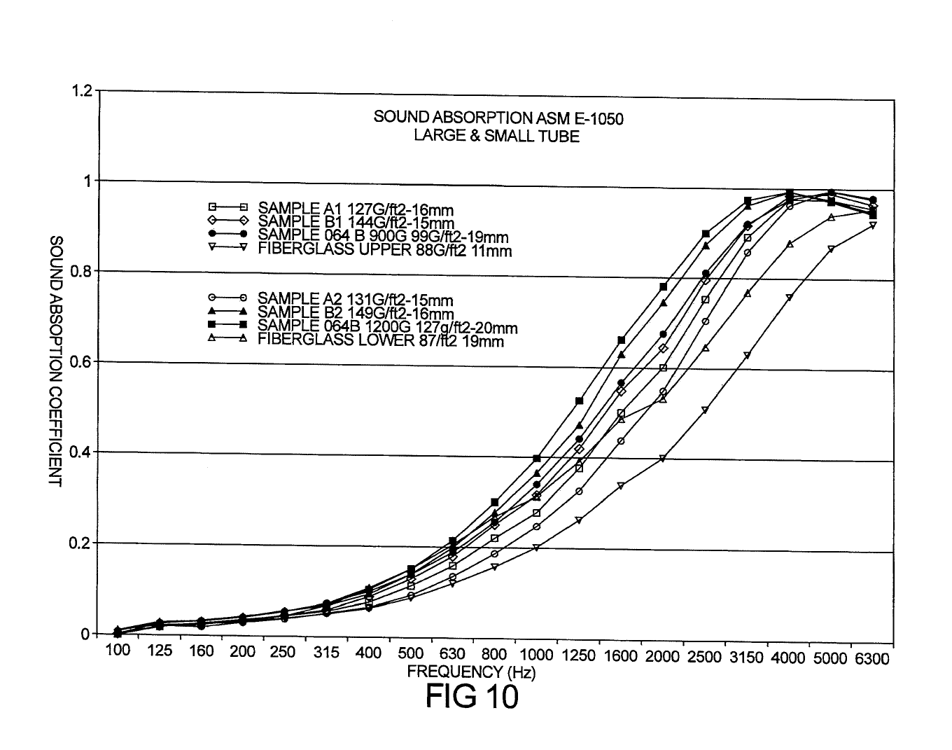

Referring to FIG. 10 and again to FIG. 9, large tube and small tube test data is illustrated comparing the acoustic attenuation of several samples of the latex impregnated fibrous acoustic insulation mats 12, 18 and/or 22 of the present disclosure to conventional fiberglass mats of similar surface density and to non-impregnated shoddy material of greater thickness. The large tube and small tube test data is presented in a plot with an x-axis (horizontal) and a y-axis (vertical). The y-axis in FIG. 10 corresponds to a sound absorption coefficient ranging from 0 to 1.2 and the x-axis corresponds to a sound frequency ranging from 100 Hertz (Hz) to 6300 Hertz (Hz). For FIG. 10, the several samples of the latex impregnated fibrous acoustic insulation mats 12, 18 and/or 22 tested also had various thicknesses and had the geometry presented in FIG. 4. Sample A1 is a sample of the latex impregnated fibrous acoustic insulation mats 12, 18 and/or 22 of the subject disclosure having a thickness of 16 millimeters (mm) and a material weight of 127 grams per square foot (g/ft²). Sample A2 is another sample of the latex impregnated fibrous acoustic insulation mats 12, 18 and/or 22 of the subject disclosure having a thickness of 15 millimeters (mm) and a material weight of 131 grams per square foot (g/ft²). Sample B1 is another sample of the latex impregnated fibrous acoustic insulation mats 12, 18 and/or 22 of the subject disclosure having a thickness of 15 millimeters (mm) and a material weight of 144 grams per square foot (g/ft²). Sample B2 is another sample of the latex impregnated fibrous acoustic insulation mats 12, 18 and/or 22 of the subject disclosure having a thickness of 16 millimeters (mm) and a material weight of 149 grams per square foot (g/ft²). Sample 064B 900G is a sample of non-impregnated shoddy material having a thickness of 19 millimeters (mm) and a material weight of 99 grams per square foot (g/ft²). Sample 064B 1200G is another sample of non-impregnated shoddy material having a thickness of 20 millimeters (mm) and a material weight of 127 grams per square foot (g/ft²). Sample FIBERGLASS UPPER is a sample of conventional fiberglass acoustic insulation material having a thickness of 11 millimeters (mm) and a material weight of 88 grams per square foot (g/ft²). Sample FIBERGLASS LOWER is a sample of conventional fiberglass acoustic insulation material having a thickness of 19 millimeters (mm) and a material weight of 87 grams per square foot (g/ft²). Similar to the data of FIG. 9, the test data of FIG. 10 indicates mats 12, 18 and/or 22 of the present disclosure have similar acoustic performance to the untreated shoddy, and in general are acoustically superior in sound absorption to conventional fiberglass mat (having a 11 mm thickness) at all frequencies, and are acoustically superior to conventional fiberglass mat (having a 19 mm thickness) at substantially all frequencies tested.

Latex impregnated fibrous acoustic insulation mats 12, 18 and/or 22 of the present disclosure have similar weight as known fiberglass acoustic panels and have similar thermal and acoustic properties. The rigidity and acoustic properties can be further varied or “tuned” on a case basis by varying the degree of penetration of latex thermoset polymeric material 58. Improvements offered by latex impregnated fibrous acoustic insulation mats 12, 18, and/or 22 compared to known fiberglass acoustic panels include increased durability and decreased process time. Where conventional fiberglass acoustic panels can typically require approximately 60 to 90 seconds to form and complete, a latex impregnated fibrous acoustic insulation mat 12, 18, and/or 22 requires only approximately 45 to 60 seconds to complete. Therefore, per unit cost reduction is further achieved by reduced production time per unit part.

Latex impregnated fibrous acoustic insulation mats 12, 18, and/or 22 also eliminate the presence of fiberglass fibers in the work area when acoustic panels prepared by the present process are used. Fiberglass fibers are typically present in the work area when conventional fiberglass acoustic panels are produced, when conventional fiberglass acoustic panels are installed in a vehicle, or when conventional fiberglass acoustic panels are removed from the vehicle at the time of repair or scrapping of the vehicle. As such, personnel respirators and protective clothing are often required. Advantageously, such precautions are not necessary when the latex impregnated fibrous acoustic insulation mats 12, 18, and/or 22 of the subject disclosure are used. Where the nonwoven material in the latex impregnated fibrous acoustic insulation mats 12, 18, and/or 22 is shoddy, fiberglass fibers are completely eliminated and therefore pose no material handling concern. Where the nonwoven material in the latex impregnated fibrous acoustic insulation mats 12, 18, and/or 22 is fiberglass, the thermoset polymeric material that is applied to the fiberglass helps reduce the amount of fiberglass fibers that are shed from the latex impregnated fibrous acoustic insulation mats 12, 18, and/or 22. This is because the thermoset polymeric material binds many of the fiberglass fibers together so that they will not separate from the rest of the latex impregnated fibrous acoustic insulation mat 12, 18, and/or 22.

The latex impregnated fibrous acoustic insulation mats 12, 18, 22 of the present disclosure also provide acoustic attenuation at reduced cost compared to fiberglass acoustic panels. Latex impregnated fibrous acoustic insulation mats 12, 18, 22 further provide rigidity compared to commercially known shoddy mats which do not contain latex thermoset polymeric material 58, which thereby permits the acoustic panel formed from latex impregnated fibrous acoustic insulation mats 12, 18, and/or 22 to be formed in a required geometry and to retain the geometry. This permits application of latex impregnated fibrous acoustic insulation mats 12, 18, and/or 22 in horizontally mounted positions and high temperature locations such as vehicle hood panels where panel sag is not allowed, and in underbody panels such as aeroshields. The thickness of the latex impregnated fibrous acoustic insulation mats 12, 18, and/or 22 can also be varied as necessary to tune the acoustic performance while meeting space constraints of the vehicle.

Testing has shown that the latex impregnated fibrous acoustic insulation mats 12, 18, and/or 22 of the present disclosure meets Underwriter Laboratory (UL) 94 V-0, V-1, and V-2 automotive standards for burn resistance. There are two types of pre-selection test programs conducted on plastic materials to measure flammability characteristics. The first determines a material's tendency to either extinguish or to spread the flame once ignited and is defined in Underwriters Laboratory (UL) 94. The Underwriters Laboratory (UL) 94 V-0 standard applies to flame retardant materials and requires that burning stops within 10 seconds on a vertical specimen, with drips of particles allowed as long as they are not inflamed. The Underwriters Laboratory (UL) 94 V-1 standard is slightly less stringent than Underwriters Laboratory (UL) 94 V-0 and requires that burning stops within 30 seconds on a vertical specimen, with drips of particles allowed as long as they are not inflamed. The Underwriters Laboratory (UL) 94 V-2 standard is slightly less stringent than Underwriters Laboratory (UL) 94 V-1 and requires that burning stops within 30 seconds on a vertical specimen, with drips of particles allowed, even if they are inflamed. Table 1, set forth below, lists several different variations of the disclosed latex impregnated fibrous acoustic insulation mats 12, 18, and/or 22 and the various Underwriter Laboratory (UL) 94 standards that each respective material meets.

TABLE 1

| Material | Meets Requirements For |
|---|---|
| A 2.5 Tenowo | V-0 V-1 V-2 |
| A 10.3 Tenowo | V-0 V-1 V-2 |
| A 2.5 NS | V-1 V-2 |
| A 10.3 NS | V-0 V-1 V-2 |
| A PFG 2.5 mm | V-0 V-1 V-2 |
| A PFG 12.7 mm | V-0 V-1 V-2 |

With reference to Table 1, the material designated as A 2.5 Tenowo is a latex impregnated fibrous acoustic insulation mat constructed in accordance with the present disclosure that has a thickness of 2.5 millimeters (mm) and includes a standard polyester scrim. The material designated as A 10.3 Tenowo is another latex impregnated fibrous acoustic insulation mat constructed in accordance with the present disclosure that has a thickness of 10.3 millimeters (mm) and includes a standard polyester scrim. The material designated as A 2.5 NS is another latex impregnated fibrous acoustic insulation mat constructed in accordance with the present disclosure that has a thickness of 2.5 millimeters (mm) and is provided without a scrim. The material designated as A 10.3 NS is another latex impregnated fibrous acoustic insulation mat constructed in accordance with the present disclosure that has a thickness of 10.3 millimeters (mm) and is provided without a scrim. The material designated as A PFG 2.5 mm is another latex impregnated fibrous acoustic insulation mat constructed in accordance with the present disclosure that has a thickness of 2.5 millimeters (mm) and includes a performance polyester scrim. Finally, the material designated as A PFG 12.7 mm is another latex impregnated fibrous acoustic insulation mat constructed in accordance with the present disclosure that has a thickness of 12.7 millimeters (mm) and includes a performance polyester scrim. One difference between the standard polyester scrim and the performance polyester scrim is the air-flow permitted through the scrim. There is greater air-flow restriction through the performance polyester scrim because the polyester fibers are more closely set. Accordingly, the performance polyester scrim creates a more arduous path for sound to travel through because the porosity of the performance polyester scrim is less than that of the standard polyester scrim.

The process of the present disclosure uses water-based acrylic latex as the thermoset polymeric material. During processing two surfaces can be bonded together, including a first substrate to a second substrate, a substrate to a scrim, a substrate to a barrier, a substrate to a foil or substrate to a film.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fibrous acoustic insulator, comprising a nonwoven mat having at least a first layer of nonwoven material impregnated with a thermoset polymeric material that is liquid-based.

2. The fibrous acoustic insulator of claim 1, further including an un-impregnated nonwoven material layer not having the thermoset polymeric material.

3. The fibrous acoustic insulator of claim 2, further including:
a second layer oppositely facing with respect to the first layer, the second layer impregnated with the thermoset polymeric material; and
the un-impregnated nonwoven material layer defining an inner layer positioned between the first and second layers.

4. The fibrous acoustic insulator of claim 3, wherein the nonwoven mat includes at least one flange having the un-impregnated nonwoven material layer completely compressed between the first and second layers.

5. The fibrous acoustic insulator of claim 1, wherein the thermoset polymeric material is a water-based acrylic latex.

6. The fibrous acoustic insulator of claim 1, wherein impregnation by the thermoset polymeric material is 5% to 100% of a total thickness of the nonwoven mat.

7. The fibrous acoustic insulator of claim 1, wherein the fibrous acoustic insulator is configured as an automotive vehicle component.

8. The fibrous acoustic insulator of claim 1, further including a flange having a thickness reduced from a thickness of the nonwoven mat.

9. The fibrous acoustic insulator of claim 1, further including a wall angularly oriented with respect to a body panel of the nonwoven mat when the nonwoven mat has been molded to a final shape.

10. The fibrous acoustic insulator of claim 1, further including at least one rib.

11. The fibrous acoustic insulator of claim 1, wherein the thermoset polymeric material includes a fire retardant material such that the fibrous acoustic insulator meets Underwriters Laboratory (UL) 94 V-0 automotive standard for burn resistance.

12. The fibrous acoustic insulator of claim 1, wherein the first layer of the nonwoven mat that is impregnated with the thermoset polymeric material extends for an entire thickness of the fibrous acoustic insulator.

13. The fibrous acoustic insulator of claim 1, wherein the thermoset polymeric material is provided in a solution including water and defines a solids content of the solution ranging between approximately 10% to approximately 75% of a volume of the solution.

14. The fibrous acoustic insulator of claim 1, having a final loft of at least 3 mm thickness.

15. The fibrous acoustic insulator of claim 1, wherein the nonwoven material is shoddy and includes a synthetic material, a natural material, a combination of synthetic and natural material, virgin or recycled material, or post industrial material consumer material.

16. The fibrous acoustic insulator of claim 1, wherein the nonwoven material is fiberglass.

17. A method for forming a fibrous acoustic insulator, comprising the steps of:
applying a thermoset polymeric material onto at least a first surface of a nonwoven mat; and
heating the nonwoven mat to cure the thermoset polymeric material.

18. The method for forming a fibrous acoustic insulator of claim 17, further comprising limiting penetration of the thermoset polymeric material to less than or equal to 30% of a thickness of the nonwoven mat.

19. The method for forming a fibrous acoustic insulator of claim 17, further comprising passing the nonwoven mat between first and second rollers such that the thermoset polymeric material is forced by the rollers to penetrate the first surface.

20. The method for forming a fibrous acoustic insulator of claim 17, further comprising applying the thermoset polymeric material onto a second surface of the nonwoven mat prior to the heating step.

21. The method for forming a fibrous acoustic insulator of claim 20, further comprising passing the nonwoven mat between first and second rollers such that the thermoset polymeric material is forced by the rollers to penetrate past the first and second surfaces each less than or equal to 30% of a thickness of the nonwoven mat, thereby leaving an inner layer of the nonwoven mat between the first and second surfaces having no thermoset polymeric material.

22. The method for forming a fibrous acoustic insulator of claim 17, further comprising compressing a portion of the nonwoven mat to create a flange.

23. The method for forming a fibrous acoustic insulator of claim 17, further comprising using water-based acrylic latex as the thermoset polymeric material.

24. The method for forming a fibrous acoustic insulator of claim 17, further comprising using water-based acrylic latex as the thermoset polymeric material, bonding two surfaces together including a first substrate to a second substrate, a substrate to a scrim, a substrate to a barrier, a substrate to a foil or substrate to a film.
